(19) United States
(12) Patent Application Publication
(10) Pub. No.: US 2012/0034417 A1
(43) Pub. Date: Feb. 9, 2012

(54) FIBER PRODUCT, MOLDED FIBER PART AND METHOD FOR PRODUCING THE SAME

(76) Inventor: Diederik Cuylits, Bersenbruck (DE)

(21) Appl. No.: 13/265,159

(22) PCT Filed: Apr. 21, 2010
(86) PCT No.: PCT/EP2010/055302

§ 371 Date: Oct. 19, 2011

(30) Foreign Application Priority Data
Apr. 21, 2009 (DE) 10 2009 002 536.7

(51) Int. Cl. B32B 3/10; D04H 13/00; D04B 21/00; B29C 69/02; D04G 1/00; F16L 5/00; B29C 43/02; B29C 35/02; F01N 1/24; D03D 15/00

(52) U.S. Cl. 428/131; 181/256; 442/327; 442/304; 442/181; 442/1; 285/383; 264/299; 264/319; 264/294

(57) ABSTRACT

According to the invention, it was recognized that the fiber products, in particular, glass fiber products, suitable for thermal insulation can be temporarily given: an inherently stable shape by fixing agents that can be activated. This enables the fiber molded parts produced from the fiber products according to the invention to be used more easily or fully automatically. Processing the fiber products to form a molded part becomes exceptionally simple if said product itself carries the fixing agents. Therefore, a fixing agent does not have to be added in a separate production step during the molding.

The invention relates to a fiber product and a molded fiber part as well as a method for producing the same. In particular, such a part can be used as a molded part for thermal and/or acoustic decoupling and/or fixation between components, and in particular as a thermally insulating wall duct, preferably in fluid-conducting systems such as, for example, components of exhaust units such as e.g. catalysts and mufflers with plastic external housings.

Novel mufflers for internal combustion engines are known from the prior art, in which the external housing consists of plastic. The muffler can thus be designed smaller and in any form for space-saving installation. What is critical in this case is the necessary thermal insulation of the wall duct in the plastic external housing through which the hot metal pipe conducting the exhaust gas is led. Because of the known properties, glass-fiber products are in this case also used as insulators. During insertion, they are frequently brought into shape by hand, optionally using several glass-fiber products. In order to facilitate assembly, these glass-fiber products can, for example, roughly kept in shape by sewing or similar aids beforehand. In another process step, sealing means are to be introduced into the area of transition between the hot metal pipe and the external housing, which ensure that the exhaust gases cannot escape between the external housing and the inner pipe.

It is therefore the object of the present invention to provide an improved fiber product and molded fiber part as well as a method for producing the same.

This object is accomplished with a fiber product, a molded fiber part as well as a method for producing the same having the features of the independent claims, as well as the wall duct or the muffler, respectively, having the features of claims 18 or 19, respectively.

For better comprehensibility, the invention is explained below with reference to “glass fibers” as an example for the fibers used. The term glass fiber is not supposed to limit the invention to products containing the material glass. Rather, the invention relates to all fibers suitable for the respective purpose of use, in particular: all organic Fibers, preferably high-temperature resistant over 100° C., preferably 120° C., particularly preferably 220°, or non-organic fibers, preferably high-temperature resistant over 300° C., preferably 350° C., e.g. mineral fibers, man-made mineral fibers, thermoplastic fibers, glass fibers, PEEK. Furthermore, it is immaterial for the invention whether the threads consist of endless filaments or short fibers. Fibers of limited length are staple fibers; fibers with basically unlimited length are filaments or endless fibers. According to the invention, a fiber product or molded part can be formed from short fibers or long filaments. Textile fabrics within the meaning of the invention also include non-woven fabrics, such as for example a needle-punched non-woven or wadding. A wadding is basically a loose structure of fibers or threads which add up to a fabric or flat structure only due to the adhesion amongst one another.

According to the invention, it was first recognized that the fiber products suitable for thermal insulation—hereinafter referred to as glass-fiber products by way of example—can temporarily obtain an inherently stable shape due to activatable fixing agents. This enables an easier or fully automatic insertion of the molded fiber parts produced from the glass-fiber products according to the invention—hereinafter referred to as molded glass-fiber parts by way of example.

Processing the glass-fiber products into a molded part becomes particularly simple if these products themselves carry the fixing agents. Therefore, a fixing agent does not have to be added in a separate production step during the bringing-into-shape process. The glass-fiber products, i.e. the substantially flexible textile fabrics, are therefore themselves carriers of the fixing agent. They may be adhesives, e.g. reactive adhesives, hot-melt adhesives, inorganic adhesives, water glass or suitable substances that were applied by spraying or immersion. What is crucial is that the fixing agent can be activated when the glass-fiber products have been brought into the appropriate shape and that, after activation, they harden in such a way that the glass-fiber products can maintain the shape it has been given at least until installation or first use.

Thermoplastics, e.g. PE, which can be activated by heat within the meaning of the invention, are another suitable fixing agent. Once the temperature has dropped below the melting temperature, the thermoplastic solidifies.

The glass-fiber products can be produced, for example, from glass-fiber threads which themselves carry the above-mentioned fixing agent. This is particularly easily carried out with the machines commonly used in the textile industry, if each glass-fiber thread is assigned one fixing thread, for example by twisting, turning, carrying along, it etc. The fixing thread preferably consists of a thermoplastic. In another embodiment the glass-fiber threads or fixing threads can also comprise a plurality of fibers which are, for example, twisted. A single thread can be composed of numerous glass-fibers and fixing fibers, whereby any mass ratios suitable for the respective purpose of use can be produced.

Woven fabrics, knits, circular-knits, knitted fabrics, scrims or braided fabrics from glass fibers are particularly suitable for producing the molded glass-fiber parts according to the invention. They are easy to handle and to bring into shape.

In experiments, the proportions of fixing agent in the glass-fiber product specified in the claims proved to be optimal with regard to handling, strength and costs.

The molded glass-fiber part according to the invention is characterized by being temporarily held in shape by the activated fixing agents. This enables a simple or fully automatic provision, handling and insertion of the corresponding molded part into other products. In particular, passing other components through the opening in the molded glass-fiber part is facilitated because jamming or the pulling-out of threads is avoided due to the smoother inner wall. According to the invention it is only important that the molded glass-fiber part is sufficiently solid during assembly. In the installed state, the molded glass-fiber part is kept in shape by the surroundings, so that the fixing agents are allowed to lose their function, e.g. by thermal decomposition of the same, without the component's thermal insulation function being impaired. Therefore, the molded glass-fiber part is to be designed in such a way that, by the activated fixing agents, it is kept in a shape that is smaller than the shape that the molded glass-fiber part would assume in the absence of the fixing agents, prior to their activation and subsequent to their thermal decomposition. Therefore, the molded glass-fiber paths is to be designed and the materials are to be selected in such a way that it would be resilient without the fixing agents, and would assume a larger shape than the desired shape of the molded glass-fiber part with activated fixing agents. Even after the thermal composition of the fixing agent, the molded part, which may basically also consist of non-glass-fibers, remains so large that it can substantially maintain its position and shape in the installed state. In that case, the molded part most frequently still has the residual resilience which, however, is substantially smaller in practice than the original resilience of the molded part prior to activation. Fiber structures which are formed as knit, knitted fabric or the like have this resilience and can be correspondingly compressed for activating the fixing agents, so that they can be brought into shape. Therefore, when producing the molded part, it must be resiliently compressible so that it can be inserted into the mold prior to the activation of the fixing agents.

Thus, the molded part is suitable for insertion as a molded part for thermal and/or acoustic decoupling and/or fixation between components. It serves as a thermally insulating insulator, in particular in the form of a wall duct, and preferably in fluid-conducting systems such as, for example, components of exhaust units such as e.g. catalysts and mufflers with plastic external housings. The damaging influences, such as e.g. temperature and vibrations, are kept away from the plastic. The molded part is particularly suitable for components of the exhaust unit of internal combustion engines, but also in the field of industry, e.g. in power stations.

Preferably, the molded glass-fiber part is configured as a so-called wall duct. It serves for insulating and optionally holding a hot component through an opening in a component to be protected from heat. Expediently, such a component comprises an inner opening for passing through the hot component, as well as an outer contour that rests on the opening in the second component to be protected. In this case, the glass-fiber component may also have a supporting function, but this is not obligatory.

According to the invention, it was found that a—most frequently rotationally symmetric—wall duct is particularly easy to produce if a circular-knit or a tube is used. For example, the latter that can be rolled inwards from both sides so that, with regard to the shape, the approximate result is a “double sealing ring”. If, in the process, more turns are made on one side, the result is already a flange-like appearance, i.e. a substantially rotationally symmetric component with a duct, a thinner flange end and a thickened flange shoulder/flange base. The external diameter of the flange shoulder can be further enlarged if the molded glass-fiber part is composed of several glass-fiber products, namely the above described circular-knits rolled up inwards or outwards, as well as for example a flat-knit wound around it in a spiral shape. During production, the prepared circular-knit can for this purpose be inserted into a corresponding flange-like negative mold, for example, and inside the mold, the part of the flange shoulder that is not filled by the circular-knit is then filled with the flat-knit. The result after the activation of the fixing agent is a flange with a broader flange shoulder.

Preferably, at least a part of the flange shoulder is provided with a pressure-tight material, e.g. an elastomer. This ensures that the inserted molded part can be pressure-tight in the installed state.

The method according to the invention - in particular for producing the aforementioned molded parts - in particular makes a cost-effective production possible that is as accurate with regard to shape, as well as, optionally, even the application of the frequently necessary seal in a single method step during the activation.

Further advantages become apparent from the following description and the attached drawing. Also, the above-mentioned features, which are explained in detail, can each be used individually or in any combinations according to the invention. The embodiments mentioned shall not be understood to be final and have the character of examples.

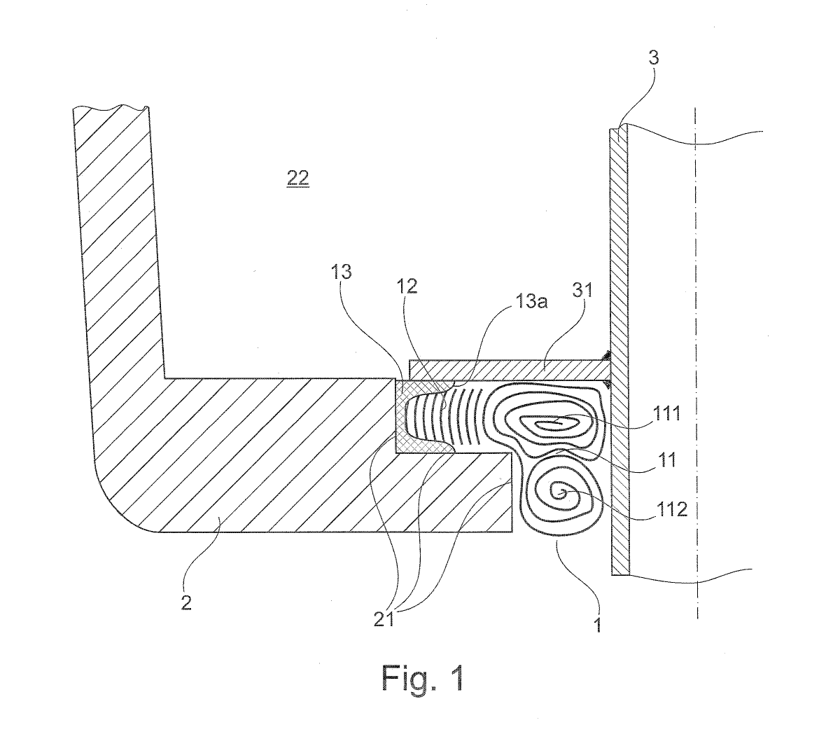

FIG. 1 shows a molded glass-fiber part 1 produced according to the invention in the installed state in a plastic muffler 2 for internal combustion engines. Of the muffler, only the area of the wall duct 21 is shown in a schematic diagram. The hot inner pipe 3 is guided through the opening 21 of the plastic housing 2 of the muffler, with the glass-fiber component 1 according to the invention being disposed in the opening 21. It thermally separates the pipe 3 from the housing 2 and at the same time serves as a pressure seal for preventing the escape of gases in the interior 22 of the muffler.

The molded part 1 is composed of two glass-fiber products 11, 12, namely a circular-knit 11 rolled up inwards and a flat-knit 12 laid around it in a spiral shape. The circular-knit 11 comprises an upper rolled-in portion 111 and a lower rolled-in portion 112, with the upper rolled-in portion 111 comprising more windings and thus requiring more volume. A flange-like external contour already results during the introduction into a corresponding—in this case flange-like—mold, so that the upper rolled-in portion 111 already forms parts of the flange shoulder. The further windings of the flat-knit 112 serve for enlarging the flange shoulder.

This widening of the flange shoulder is necessary for thermal reasons connected with the necessary diameter of the metallic pressure plate 31 which is firmly connected to the inner pipe 3. This plate 31 is necessary in order to produce the pressure-sealing effect. The larger the plate, the colder the outer end of the plate. This reduces the thermal load on the necessary pressure seal 13 in this area, which is located at the outer part of the flange shoulder 12. The seal 13 was molded onto the outer flange end by injection of sealing material during production, and has the task of providing a pressure-tight seal between the plate 31 and the inner contour of the opening 21 of the external housing 2.

Two bowl-like half-shells are provided as an external housing 2 for assembling the muffler. The molded glass-fiber parts 1 produced according to the invention are inserted into the opening of the external housing 2. Then, both half-shells 2 are pulled over the opposing free ends of the inner pipe 3 and connected to each other. The necessary pressure between the plate 31, the inner opening 21 and the seal 13 of the molded glass-fiber part is produced thereby.

A single-part construction with an integrated seal 13 is preferred according to the invention. However, the seal can also be provided separately as a sealing ring. In view of the high demands with regard to the heat-resistance of the sealing material, however, the integral construction according to the invention offers the advantage that only comparatively little sealing material is used since it largely rests against the glass-fiber product all around it.

Preferably, the top surface of the sealing material 13 protrudes over the top side of the glass-fiber material so that an optimum and uninterrupted contact of the sealing material with the plate 31 is ensured. During production, this is advantageously accomplished by corresponding recesses for the sealing material in the negative mold. They accommodate the material, provide it with a defined and suitable surface in the hardened state, and ensure that the glass-fiber material is well-hidden in the sealing material.

1. Fiber product, e.g. glass-fiber product, in particular textile fabric, with activatable fixing agents, which is such that the fiber product kept in a mold can retain its shape after the activation of the fixing agents and after the removal of the mold, characterized in that
it is resiliently compressible prior to the activation of the fixing agents and subsequent to their thermal decomposition;
the fiber product comprises threads, in particular glass-fiber threads, which carry the fixing agent;
the fixing agent is configured as fixing threads, which are conducted on, in, about and/or next to the threads;
each thread consists of a plurality of fibers, in particular twisted ones, and/or each fixing thread consists of a plurality of fixing fibers, in particular twisted ones;
a plurality of fibers and at least one fixing fiber are twisted together and jointly form the thread,
the fixing threads consist of or comprise a thermoplastic;
the fiber product is a thread, woven fabric, knit, circular-knit, flat-knit, knitted fabric, scrim, parallel braiding, wadding, non-woven fabric or braided fabric from glass fibers or glass-fiber threads;
the proportion of the fixing agent in the fiber product is 1-30% by wt., preferably 3-15% by wt., and particularly preferably 4-10% by wt.

2. Fiber product, e.g. glass-fiber product, in particular textile fabric, with activatable fixing agents, which is such that the fiber product kept in a mold can retain its shape after the activation of the fixing agents and after the removal of the mold.

3. Fiber product according to claim 2, characterized in that it is resiliently compressible prior to the activation of the fixing agents and subsequent to their thermal decomposition.

4. Fiber product according to claim 2, characterized in that the fiber product comprises threads, in particular glass-fiber threads, which carry the fixing agent.

5. Fiber product according to claim 1, characterized in that the fixing agent is configured as fixing threads, which are conducted on, in, about and/or next to the threads.

6. Fiber product according to claim 1, characterized in that each thread consists of a plurality of fibers, in particular twisted ones, and/or each fixing thread consists of a plurality of fixing fibers, in particular twisted ones.

7. Fiber product according to claim 1, characterized in that a plurality of fibers and at least one fixing fiber are twisted together and jointly form the thread.

8. Fiber product according to claim 1, characterized in that the fixing threads consist of or comprise a thermoplastic.

9. Fiber product according to claim 1, characterized in that the fiber product is a thread, woven fabric, knit, circular-knit, flat-knit, knitted fabric, scrim, parallel braiding, wadding, non-woven fabric or braided fabric from glass fibers or glass-fiber threads.

10. Fiber product according to claim 1, characterized in that an adhesive is provided as a fixing agent.

11. Fiber product according to claim 1, characterized in that the proportion of the fixing agent in the fiber product is 1-30% by wt., preferably 3-15% by wt., and particularly preferably 4-10% by wt.

12. Molded fiber part, e.g. a molded glass-fiber part, in particular a thermal insulation with a fiber product according to claim 1, which is kept in shape by the activated fixing agents, characterized in that
by the activated fixing agents, it is kept in a shape that is smaller than the shape that the molded part would assume in the absence of the fixing agents or after their thermal decomposition;
the molded part comprises an inner opening for passing through and holding a heat-conducting component, as well as an outer contour for holding the thermal insulation in a second component that is to be protected against the heat of the heat-conducting component;
the molded part comprises a circular-knit as a fiber product which is rolled up inwards or outwards from one or both ends;
the molded part is composed of several fiber products;
the molded part is configured in the shape of a flange;
the flange comprises a circular-knit which is rolled up inwards or outwards from one or both ends, and the flange shoulder consists at least partially of a further fiber product, in particular of a flat-knit wound about the flange;
the outer part of the flange shoulder is provided with a pressure-tight material, e.g. a temperature-resistant elastomer, such as silicone rubber, in such a way that the flange shoulder is pressure-tight in the installed state;
the molded part is used for thermal and/or acoustic decoupling and/or fixation between components, e.g. as a thermally insulating wall duct, preferably in fluid-conducting systems such as, for example, components of exhaust units such as e.g. catalysts and mufflers, in particular with plastic external housings.

13. Molded fiber part, e.g. a molded glass-fiber part, in particular a thermal insulation with a fiber product according to claim 1, which is kept in shape by the activated fixing agents.

14. Molded part according to claim 1, characterized in that, by the activated fixing agents, it is kept in a shape that is smaller than the shape that the molded part would assume in the absence of the fixing agents or after their thermal decomposition.

15. Molded part according to claim 1, characterized in that the molded part comprises an inner opening for passing through and holding a heat-conducting component, as well as an outer contour for holding the thermal insulation in a second component that is to be protected against the heat of the heat-conducting component.

16. Molded part according to claim 1, characterized in that the molded part the molded part comprises a circular-knit as a fiber product which is rolled up inwards or outwards from one or both ends.

17. Molded part according to claim 1, characterized in that the molded part is composed of several fiber products.

18. Molded part according to claim 1, characterized in that the molded part is configured in the shape of a flange.

19. Molded part according to claim 18, characterized in that the flange comprises a circular-knit which is rolled up inwards or outwards from one or both ends, and the flange shoulder consists at least partially of a further fiber product, in particular of a flat-knit wound about the flange.

20. Molded part according to claim 19, characterized in that the outer part of the flange shoulder is provided with a pressure-tight material, e.g. a temperature-resistant elastomer, such as silicone rubber, in such a way that the flange shoulder is pressure-tight in an installed state.

21. Molded part according to claim 1 for thermal and/or acoustic decoupling and/or fixation between components, e.g. a thermally insulating wall duct, preferably in fluid-conducting systems such as, for example, components of exhaust units such as e.g. catalysts and mufflers, in particular with plastic external housings.

22. Wall duct in a wall for passing through and holding a heat-conducting component in a second component that is to be protected against the heat of the heat-conducting component, comprising a molded part according to claim 1.

23. Muffler for internal combustion engines, comprising a metal inner pipe perforated in some sections, a plastic external housing, insulating materials between the inner pipe and the external housing as well as a molded part or wall duct according to claim 1 which holds the inner pipe and insulates it from the external housing.

24. Method for producing a molded part, in particular according to claim 1, comprising the following steps:
a. providing one or more fiber products according to claim 1;
b. introducing the fiber product into a negative mold that corresponds to the shape of the fiber product to be produced;
c. activating the fixing agents;
d. removal of the mold after the activating agents have reached the state that enables the fiber products to retain their shape after the removal of the mold.

25. Method according to claim 24, wherein the fiber product is resiliently compressed in step b).

26. Method according to claim 1, wherein thermoplastics are used as fixing agents and the activation takes place by introducing heat into and melting the thermoplastics.

27. Method according to claim 1, wherein the mold is put under pressure during the activation.

28. Method according to claim 1, wherein, between steps b) and d), and in addition to step c), a coating is introduced, e.g. by injection into the mold, which serves as a pressure seal on the finished molded part.

29. Method according to claim 28, wherein the coating hardens during the activation of the fixing agent, for example by a vulcanization process.
